(19) United States
(12) Patent Application Publication
(10) Pub. No.: US 2021/0291424 A1
(43) Pub. Date: Sep. 23, 2021

(54) APPARATUS FOR MANUFACTURING THERMOPLASTIC ADHESIVE PRODUCT

(71) Applicant: MORESCO CORPORATION, Hyogo (JP)

(72) Inventors: Hiroki IWASE, Hyogo (JP); Yutaka NAGAI, Hyogo (JP)

(21) Appl. No.: 17/338,184

(22) Filed: Jun. 3, 2021

Related U.S. Application Data
(62) Division of application No. 16/320,383, filed on Jan. 24, 2019.

(30) Foreign Application Priority Data
Jul. 27, 2016 (JP) 2016-147690
Feb. 1, 2017 (JP) 2017-017148

(51) Int. Cl. B29C 48/28; B29C 48/18; C09J 201/00; C09J 7/10; B29C 48/92; C09J 7/38; B29C 48/30; B29C 48/88

(52) U.S. Cl. CPC B29C 48/28; B29C 48/18; C09J 201/00; C09J 7/10; B29K 2101/12; C09J 7/383; B29C 48/30; B29C 48/911; B29C 48/92

(57) ABSTRACT

An embodiment of the present invention provides (i) a method for producing a thermoplastic adhesive product which can be continuously and automatically supplied and (ii) an apparatus for producing the thermoplastic adhesive product. The method includes the steps of: a) extruding a long object through a discharge hole of an extruder, the long object being made of a thermoplastic adhesive and having a string shape or a sheet shape; b) cooling the long object having been thus extruded; and c) collecting the long object having been thus cooled. The production apparatus (100) includes an extruder (101), cooling equipment (102), and a winder (107).

### TECHNICAL FIELD

The present invention relates to a method for producing a thermoplastic adhesive product and an apparatus for producing the thermoplastic adhesive product.

### BACKGROUND ART

Thermoplastic adhesives, which are heated to melt into liquid state prior to application, are in solid state at room temperature. Generally, thermoplastic adhesive products are provided in the form of blocks, and are heated to melt when used. Accordingly, conventional thermoplastic adhesive products have an issue in that they may unite with each other because of heat and/or stress they have experienced during, for example, storage before use, and/or that a thermoplastic adhesive sticks to a packing container. Conventional thermoplastic adhesive products are thus difficult to handle.

Some techniques have been proposed to address the above issue(s). Known examples of such techniques include (1) a method by which a thermoplastic adhesive, which has been heated to its flow temperature or above, is filled into a porous container coated with wax while the container is being cooled; and thereafter the container is cooled until the surface of the thermoplastic adhesive solidifies, and thereafter the thermoplastic adhesive is removed from the container by contacting the container with hot water having a temperature equal to or above the melting point of the wax (Patent Literature 1), (2) a method by which a thermoplastic adhesive composition is kneaded while heated at a temperature equal to or below a certain temperature in an extruder and is extruded from the extruder into a bar form, and the composition thus extruded is cut into particles (pellets) while being cooled (Patent Literature 2), and (3) a method by which an adhesive product in liquid state is coated with a non-adhesive protective coat by a co-extrusion method, and a thermoplastic adhesive product is thus obtained (Patent Literature 3).

### CITATION LIST

### Patent Literature

[Patent Literature 1] Japanese Patent Application Publication, Tokukai, No. 2003-20467 (Publication Date: Jan. 24, 2003)

[Patent Literature 2] Japanese Patent Application Publication, Tokukai, No. 2000-256643 (Publication Date: Sep. 19, 2000)

[Patent Literature 3] Japanese Patent Application Publication, Tokukaihei, No. 11-348912 (Publication Date: Dec. 21, 1999)

### SUMMARY OF INVENTION

### Technical Problem

However, the above conventional thermoplastic adhesive products have an issue in that it is difficult to supply the conventional thermoplastic adhesive products continuously to a hot melt tank provided to an applicator device when they are applied to an adherend. That is, conventional methods for producing a thermoplastic adhesive product have a room for improvement, from the viewpoint of producing a thermoplastic adhesive product which can be supplied continuously to a hot melt tank.

For example, a thermoplastic adhesive product obtained by the method disclosed in Patent Literature 1 has an issue in that portions of the thermoplastic adhesives exposed from the porous containers may stick to each other when the thermoplastic adhesive products are packed. Further, the thermoplastic adhesive product also has an issue in that the thermoplastic adhesive product necessitates a troublesome process of separating the porous container and the thermoplastic adhesive from each other when the product is used. Therefore, it is difficult to continuously supply, to a hot melt tank, the thermoplastic adhesive product obtained by the method disclosed in Patent Literature 1.

The technique disclosed in Patent Literature 2 has an issue in that, in a case where a highly adhesive thermoplastic adhesive is produced, the thermoplastic adhesive adheres to a cutter of a cutting unit of a granulator, and therefore this technique is not suitable for use in producing highly adhesive thermoplastic adhesives. In addition, the thermoplastic adhesive product in the technique disclosed in Patent Literature 2 has been cut into particles (pellets). Therefore, even in a case where such pellets of the thermoplastic adhesive product are supplied altogether to a hot melt tank, continuous supply, without intervals, of the pellets into the hot melt tank cannot be easily achieved.

The shape of the thermoplastic adhesive product disclosed in Patent Literature 3 is a so-called “pillow shape”. That is, each thermoplastic adhesive product in Patent Literature 3 is in a single pillow form. Therefore, as with the thermoplastic adhesive product disclosed in Patent Literature 2, it is not easy to continuously supply, without intervals, the thermoplastic adhesive product disclosed in Patent Literature 3 to a hot melt tank. In addition, the thermoplastic adhesive product disclosed in Patent Literature 3 has an issue in that it takes a long time to cool and dry the thermoplastic adhesive product when the thermoplastic adhesive product is produced. This is because of the shape and thickness of the thermoplastic adhesive product. The thermoplastic adhesive product disclosed in Patent Literature 3 also has an issue that the quality of the thermoplastic adhesive product is unstable, because the aforementioned non-adhesive protective coat becomes uneven in thickness when the product is formed into a pillow shape.

As has been described, it is difficult to continuously supply, to a hot melt tank, any of the conventional thermoplastic adhesive products, such as the thermoplastic adhesive products disclosed in Patent Literatures 1 to 3. However, no progress has been made in development of an automated technique to introduce thermoplastic adhesive products into a hot melt tank. Thus, in existing techniques, the thermoplastic adhesive products require manual operation to be introduced into a hot melt tank.

As such, the conventional thermoplastic adhesive products require some improvement, from the viewpoint of work efficiency in using the thermoplastic adhesive products. In addition, first of all, production efficiency of conventional thermoplastic adhesive products, such as the thermoplastic adhesive product disclosed in Patent Literature 3, is far from satisfactory.

The present invention was made in view of the above issues. An object of the present invention is to provide a production method and a production apparatus each of which makes it possible to easily produce a thermoplastic adhesive product that can be automatically and continuously supplied to a hot melt tank provided to an applicator device.

### Solution to Problem

In order to attain the above object, the inventors of the present invention have conducted diligent studies on, for example, the relationship between the shape of a thermoplastic adhesive product and continuous supply of the thermoplastic adhesive product. As a result, the inventors have found that a thermoplastic adhesive product having a certain three-dimensional shape can be easily produced by using certain steps and certain equipment in combination. On the basis of this finding, the inventors have accomplished the present invention.

A method for producing a thermoplastic adhesive product in accordance with an embodiment of the present invention includes the steps of: (a) extruding a long object through a discharge hole of an extruder, the long object being made of a thermoplastic adhesive and having a string or a sheet shape; (b) cooling the long object thus extruded in the step (a); and (c) collecting the long object thus cooled in the step (b).

An apparatus for producing a thermoplastic adhesive product in accordance with an embodiment of the present invention includes: an extruder configured to extrude a long object, which long object is made of a thermoplastic adhesive and has a string or a sheet shape; cooling equipment configured to cool the long object thus extruded from the extruder; and a winder configured to wind the long object thus cooled by the cooling equipment.

### Advantageous Effects of Invention

An embodiment of the present invention makes it possible to avoid sticking between thermoplastic adhesives, and also makes it possible to easily produce a thermoplastic adhesive product which can be continuously and automatically introduced into a hot melt tank. As such, an embodiment of the present invention bring about an effect of making it possible to easily produce a thermoplastic adhesive product which has a dramatically improved handleability and which dramatically improves work efficiency in using the thermoplastic adhesive product.

### BRIEF DESCRIPTION OF DRAWINGS

FIG. 1 is a view schematically illustrating one example of a production apparatus (production apparatus in accordance with an embodiment of the present invention) for use in a method for producing a thermoplastic adhesive product in accordance with an embodiment of the present invention.

FIG. 2 shows the appearance of a roll of a string-shape thermoplastic adhesive product produced in an Example.

FIG. 3 is a view schematically illustrating one example of the shape of a thermoplastic adhesive product obtainable by a production method in accordance with an embodiment of the present invention or a production apparatus in accordance with an embodiment, and illustrates one example of the appearance of a long object having a string shape.

FIG. 4 is a view schematically illustrating one example of the shape of a thermoplastic adhesive product obtainable by a production method in accordance with an embodiment of the present invention or a production apparatus in accordance with an embodiment, and illustrates how the thermoplastic adhesive product having a sheet shape is rolled up.

FIG. 5 shows the appearance of a pillow-shape thermoplastic adhesive product of a Comparative Example.

FIG. 6 shows the appearance of a block-shape thermoplastic adhesive product of a Comparative Example whose surface has been treated to be easily releasable (or detachable).

FIG. 7 shows the appearance of a block-shape thermoplastic adhesive product of a Comparative Example.

### DESCRIPTION OF EMBODIMENTS

The following description will discuss one or more embodiments of the present invention. Note, however, that the present invention is not limited to the following embodiments, but can be altered by a skilled person in the art within the scope of the claims. The present invention also encompasses, in its technical scope, any embodiment or example derived by combining technical means disclosed in differing embodiments and/or examples. All academic and patent literatures listed herein are incorporated herein by reference. Note that the expression “A to B”, representing a numeric range, herein means “not less than A and not more than B” unless otherwise specified in this specification.

### [1. Method for Producing Thermoplastic Adhesive Product]

A method for producing a thermoplastic adhesive product in accordance with an embodiment of the present invention includes the steps of: (a) extruding a long object through a discharge hole of an extruder, the long object being made of a thermoplastic adhesive and having a string or a sheet shape; (b) cooling the long object thus extruded in the step (a); and (c) collecting the long object thus cooled in the step (b).

The term “method for producing a thermoplastic adhesive product in accordance with an embodiment of the present invention” herein is also referred to simply as “the present production method”. The term “the present production method” by no means limits the method for producing a thermoplastic adhesive product, and merely means one embodiment of the above method for producing a thermoplastic adhesive product.

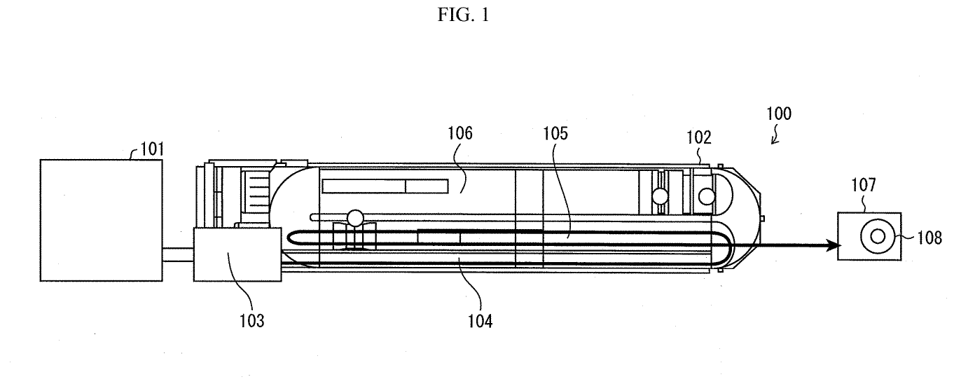

A production apparatus for carrying out the present production method is not limited to a particular one, provided that the production apparatus is capable of carrying out the present production method. The production apparatus for carrying out the present production method is suitably a production apparatus as described later in [2. Apparatus for producing thermoplastic adhesive product]. For example, a production apparatus illustrated in FIG. 1 is suitably used as the production apparatus for carrying out the present production method. The following will discuss the present production method with reference to FIG. 1.

FIG. 1 is a view schematically illustrating an example of a production apparatus for use in the present production method. A production apparatus 100 includes an extruder 101, cooling equipment 102, and a winder 107. The extruder 101, the cooling equipment 102, and the winder 107 are connected together in this order. Connections between the extruder 101 and the cooling equipment 102 and between the cooling equipment 102 and the winder 107 each can be a direct connection or a connection formed by carrier equipment such as a pipe or a belt conveyer. Note however that preferably, the extruder 101 and the cooling equipment 102 are connected directly to each other as described later.

In FIG. 1, an arrow heading from the cooling equipment 102 to the winder 107 schematically shows a direction in which a long object is carried. The long object extruded from the extruder 101 is discharged into the cooling equipment 102. The long object cooled by the cooling equipment 102 is wound by the winder 107.

The production apparatus 100 illustrated in FIG. 1 includes the winder 107 as a device for carrying out the step of collecting the long object (collection step). In the present production method, the collection step can be carried out with use of the winder 107 or without use of the winder 107. Note however that in the present production method, the collection step is preferably carried out with use of the winder 107 as described later.

The following will discuss details of each component of the present production method.

### <1-1. Long Object>

The present production method includes the step of extruding a long object through a discharge hole of an extruder (extrusion step), the long object being made of a thermoplastic adhesive product and having a string shape or a sheet shape. Therefore, first, the long object will be described below. Note that in the following description, a long object extruded from an extruder may also be referred to as an extruded product. The long object is made of a thermoplastic adhesive product and has a string shape or a sheet shape.

The term “long object” herein refers to a three-dimensional structure that has opposite ends and an intermediate portion.

The term “long object having a string shape” refers to any long object in which the length of the intermediate portion is greater than the inner diameter of a cross section perpendicular to the lengthwise direction of the long object. The shape of the cross section is not particularly limited, but is preferably substantially circular or substantially oval because such a long object is easily collected and is capable of being uniformly coated (coating will be described later). Having the above shape is preferable also from the viewpoint of easy winding. The long object having a string shape may also be referred to as a long object in the form of a rope.

The term “inner diameter” refers to the diameter of a circle inscribed in a cross section (two-dimensional shape) perpendicular to the lengthwise direction of the long object. For example, in a case where the cross section is in the shape of a circle, the “inner diameter” refers to the diameter of the circle, whereas, in a case where the cross section is in the shape of an oval, the “inner diameter” refers to the length of the minor axis of the oval.

The term “long object having a sheet shape” refers to a long object whose cross section perpendicular to the lengthwise direction of the long object is a rectangle in shape and the length of the intermediate portion is greater than each of the long and short sides of the rectangle.

The long object preferably has a string shape. In a case where the long object having a string shape and the long object having a sheet shape are each made of the same amount of thermoplastic adhesive product, the long object having a string shape is generally thicker than the long object having a sheet shape. Further, when the long object is wound, an area where any adjacent faces of the intermediate portion of the long object are in contact with each other is smaller in the case of the long object having a string shape as compared to the case of the long object having a sheet shape. Therefore, as compared to the long object having a sheet shape, the long object having a string shape allows for (1) easier collection of the long object in the collection step (described later), (2) uniform coating (described later) of the long object, and (3) easier retention of the shape of the long object after extrusion of the long object from the extruder in the extrusion step (described later) and until collection or winding of the long object in the collection step.

The length of the long object is preferably not less than 1 m. When the length of the long object is not less than 1 m, a larger amount of the thermoplastic adhesive product ultimately obtained can be automatically introduced into a hot melt tank. This makes it possible to improve work efficiency.

The upper limit of the length of the long object is not limited in any way. A long object having a longer length is more preferred. Increasing the length of the long object without an upper limit is technically possible. In practical use, the upper limit of the length of the long object is preferably, for example, 100 m to 1000 m, in order to achieve easy handling and the like. Note, however, that the upper limit of the length of the long object is not limited as such, as described earlier.

The inner diameter of a cross section perpendicular to the lengthwise direction of the long object is preferably 5 mm to 300 mm, more preferably 5 mm to 100 mm, even more preferably 5 mm to 50 mm, most preferably 5 mm to 15 mm, for faster production and a shorter time for the long object to be cooled in the production process.

The thermoplastic adhesive is obtained by adding, depending on need, some additive(s) such as a tackifier resin and/or waxes to a thermoplastic resin. The thermoplastic adhesive can be a known thermoplastic adhesive. The thermoplastic resin is not limited to a particular kind. Examples of the thermoplastic resin include ethylene-vinyl acetate copolymers, ethylene-acrylate copolymers, atactic polypropylene, and amorphous poly(α-olefin), which are in liquid state at a temperature of 50° C. to 200° C. These thermoplastic resins can be used independently or two or more of them can be used in combination.

Examples of the tackifier resin include: natural resins such as those available under the trade names such as gum rosin, wood rosin, and tall oil rosin; modified rosins such as rosin polymers and partially hydrogenated rosins; derivatives of rosins and of modified rosins including (1) glycerol ester rosins, partially hydrogenated versions of the glycerol ester rosins, completely hydrogenated versions of the glycerol ester rosins, polymers of the glycerol ester rosins, and the like and (2) pentaerythritol esters, partially hydrogenated versions of the pentaerythritol esters, completely hydrogenated versions of the pentaerythritol esters, polymers of the pentaerythritol esters, and the like; polyterpene-based resins such as polymers of α-pinene, polymers of β-pinene, and dipentene polymers; modified terpenes such as terpene-phenol copolymers and α-pinene-phenol copolymers; aliphatic petroleum resins; alicyclic petroleum resins; cyclopentadiene resins; aromatic petroleum resins; phenolic resins; alkyl phenol-acetylene-based resins; styrene-based resins; xylene-based resins; coumarone-indene resins; vinyltoluene; and α-methylstyrene copolymers.

Examples of the waxes include carnauba wax, montan wax, paraffin wax, and microcrystalline wax. It is particularly preferable to use waxes at least one of which is a paraffin-based wax or a Fischer-Tropsch wax that contains 85 wt. % or more n-paraffin component.

The thermoplastic adhesive can contain some additive(s) depending on need, such as an antioxidant, an ultraviolet absorber, filler, and/or a colorant.

An example of a typical synthetic-rubber-based thermoplastic adhesive is a thermoplastic adhesive that contains a synthetic rubber, a tackifier, an olefin-based resin, and an additive(s) (the total of these constituents is 80 wt. % to 95 wt. %) and a lubricant base oil (5 wt. % to 20 wt. %) such that the total is 100 wt. %.

### <1-2. Extrusion Step>

The present production method includes the step of extruding a long object through a discharge hole of an extruder (extrusion step), the long object being made of a thermoplastic adhesive and having a string shape or a sheet shape. The extruder is not particularly limited, provided that the extruder can extrude a long object. The extruder can be, for example, a device including a cylinder, a screw provided in the cylinder, and a discharge hole via which a long object is discharged from inside the cylinder. The extruder configured as described above can knead, by use of the screw, a thermoplastic adhesive introduced into the cylinder, and then extrude, through the discharge hole, the thermoplastic adhesive thus kneaded.

Note that the extruder can include one (1) screw or two or more screws. In other words, the extruder can be a single screw extruder or a twin screw extruder or multi-screw extruder.

The diameter of the discharge hole is not particularly limited. For example, the diameter falls within the range of preferably 5 mm to 300 mm, more preferably 5 mm to 100 mm, even more preferably 5 mm to 50 mm, most preferably 5 mm to 15 mm. The discharge hole, whose diameter falls within the above range, can more efficiently extrude a long object.

The extruder is preferably a co-extruder. In other words, the extrusion step of the present production method is preferably a co-extrusion step in which an extruder, that includes a co-extrusion die as the discharge hole, is employed. Since such an extruder (that is, a co-extruder) configured as above is used in the extrusion step, it is possible to co-extrude, for example, a thermoplastic adhesive and a non-adhesive material (described later) in the extrusion step. This easily allows for a production of a thermoplastic adhesive product in which (i) the thermoplastic adhesive constitutes a core part and (ii) a surface of the core part is partially or entirely coated with a non-adhesive material.

In the extrusion step, the extruder can be used together with a hopper which is configured to introduce, into the extruder and/or the like, a raw material(s) of the thermoplastic adhesive and/or the non-adhesive material. In other words, the extruder for use in the extrusion step can include the hopper.

In the extrusion step, the long object is extruded through the discharge hole of the extruder, as described above. In the extrusion step, one (1) extruder or two or more extruders can be used. Specifically, in a case where one (1) extruder is employed, the discharge hole means a discharge hole of that one extruder. Meanwhile, in a case where two or more extruders are employed, the discharge hole means discharge holes of the two or more extruders.

Each extruder can have one (1) discharge hole. Alternatively, each extruder can have one or two or more discharge holes. In a case where each extruder has two or more discharge holes, the long object can be extruded by using all the two or more discharge holes or by using some of the two or more discharge holes.

The extrusion step is preferably carried out such that the long object is extruded through two or more discharge holes of each extruder. This configuration allows the long object to be simultaneously extruded in a plurality of rows. This allows an increase in extruding rate in the extrusion step, such that the extruding rate for each extruder falls, for example, within the range of 1000 kg/h to 2000 kg/h. Therefore, the configuration is advantageous in a case where the thermoplastic adhesive product is mass-produced.

The preferred number of discharge holes for each extruder cannot be uniformly defined. This is because the number depends on a required production amount of the long object. But then, the preferred number of discharge holes can be two or more, three or more, four or more, or six or more. The upper limit of the number of discharge holes is preferably eight or less, more preferably six or less, even more preferably four or less, from the viewpoint of reducing the number of long objects to be processed in parallel to each other after the extrusion step.

Meanwhile, the extruding rate for each extruder can be adjusted as appropriate, depending on a production amount of the long object. Accordingly, the extruding rate for each extruder does not necessarily fall within the range of 1000 kg/h to 2000 kg/h. The extruding rate for each extruder can fall, for example, within the range of 10 kg/h to 1000 kg/h, 10 kg/h to 500 kg/h, 30 kg/h to 400 kg/h, or 40 kg/h to 200 kg/h.

Further, in the extruder, the temperature of the long object which is immediately before discharge of the long object is set to a temperature which falls within the range of preferably 100° C. to 200° C., more preferably 110° C. to 180° C., even more preferably 120° C. to 150° C., from the viewpoint of more efficiently extruding the long object.

The “temperature of the long object immediately before discharge of the long object” can be actually measured, for example, by the following method. That is, a thermometer is provided in a pipe immediately before the discharge hole. Then, the temperature of the thermoplastic adhesive, which flows in the pipe immediately before discharge of the thermoplastic adhesive, is measured by use of the thermometer. The temperature of the long object immediately before discharge of the long object can be set in the above range by, for example, a method according to which (i) first, a test is carried out, in which test the “temperature of the long object immediately before discharge of the long object” is measured by the above-described method while the long object is extruded under various conditions, and then, (ii) the extruder is configured, on the basis of a result of the test, such that the temperature of the long object immediately before discharge of the long object will fall within the above range.

### <1-3. Cooling Step>

The present production method includes the step of cooling the long object which has been extruded in the extrusion step (cooling step). In the cooling step, the long object, which has been extruded in the extrusion step, is discharged into cooling equipment. This causes the long object to be cooled and solidified by the cooling equipment. Since the present production method includes the cooling step, it is possible to easily collect, in the collection step (described later), the long object which has been solidified in the cooling step. In a case where the collection step in the present production method is a winding step in which the long object is collected by winding, it is possible to easily collect, in the winding step, the long object which has undergone the cooling step. The long object which has been cooled in the cooling step, that is, the long object which has been solidified in the cooling step is hereinafter referred to as “thermoplastic adhesive product”.

In the present production method, whether or not the long object is in a “solidified” state is determined by whether or not a central portion of the long object has reached a temperature lower than the softening point of the long object. Note that the “central portion of the long object” hereinafter refers to a central portion in a cross section of the long object, which cross section is obtained by cutting the long object along a direction perpendicular to the lengthwise direction of the long object. Note also that the long object is in a “solidified” state when the central portion of the long object has reached a temperature of, for example, 40° C. to 50° C.

Note that extrusion in the extrusion step and cooling in the cooling step can be carried out inconsecutively or consecutively. Extrusion in the extrusion step and cooling in the cooling step are inconsecutively carried out, for example, in a case where the long object, which has been extruded through the discharge hole of the extruder, is carried by carrier equipment such as a pipe or a belt conveyer and is then fed into the cooling equipment.

On the other hand, extrusion in the extrusion step and cooling in the cooling step are consecutively carried out, for example, in a case where the discharge hole of the extruder is directly connected to the cooling equipment such that the long object extruded through the discharge hole is directly fed into the cooling equipment. This makes it possible to immediately cool the long object thus extruded. Accordingly, it is preferable to consecutively carry out extrusion in the extrusion step and cooling in the cooling step, from the viewpoint of more easily retaining the shape of the long object.

The form of the cooling equipment for use in the cooling step is not particularly limited, and can be a water pool or a flow channel. The cooling equipment is preferably a flow channel, from the viewpoint of easily retaining the shape of the long object and efficiently carrying the long object. In other words, the dimensions of the cooling equipment is preferably arranged such that the length of the cooling equipment parallel to the direction in which the long object is carried is greater than the inner diameter of the cross section of the cooling equipment perpendicular to the direction in which the long object is carried.

The cooling equipment including the flow channel is also referred to as a “cooling channel”. In the cooling step, the use of the cooling channel makes it possible to easily guide the long object to the collection step (describe later). Further, the shape of the cooling channel is not particularly limited. The cooling channel can therefore be, for example, linearly-shaped, U-shaped, S-shaped, or spiral-shaped.

The cooling step is preferably carried out such that the long object, which is extruded through each of the two or more discharge holes, is fed into a corresponding one of flow channels which are provided so as to correspond to the two or more discharge holes, respectively.

In other words, the number of flow channels, which are provided in the cooling channel, preferably matches the number of the discharge holes through each of which the long object is extruded. More specifically, in a case where, in the extrusion step, the long object is extruded through each of two or more discharge holes for each extruder, the cooling channel preferably includes flow channels whose number corresponds to the total number of the two or more discharge holes. In a case where, in the extrusion step, the long object is extruded through each of discharge holes of a plurality of extruders each having one (1) discharge hole, the cooling channel preferably includes flow channels whose number corresponds to the total number of the discharge holes.

In a case where the number of flow channels, which are provided in the cooling channel in the present production method, matches the number of the discharge holes, one (1) long object is fed into a corresponding one of the flow channels. This advantageously makes it possible to prevent neighbor long objects from entangling with each other in a flow channel.

The number of flow channels in the cooling channel can be smaller than the number of discharge holes, and can therefore be, for example, one (1). In a case where the number of flow channels, which are provided in the cooling channel, is smaller than the number of the discharge holes, two or more long objects are simultaneously cooled in one (1) flow channel after the two or more long objects are extruded through corresponding two or more discharge holes. This advantageously makes it possible to save solvent and/or reduce the size of the cooling equipment.

The cooling equipment for use in the cooling step is not particularly limited, provided that the cooling equipment is configured to be capable of cooling and solidifying the long object. Examples of the cooling equipment include cooling equipment which contains a cooling medium, cooling equipment which is provided with a shower for spraying a cooling medium, and cooling equipment which is provided with a fan for air cooling. In the cooling step in the present production method, it is preferable to use, as the cooling equipment, cooling equipment which contains a cooling medium. This allows the long object to be discharged into a cooling medium, so that the entire portion of the long object can be surrounded by the cooling medium and uniformly cooled.

The cooling medium used in the cooling step is, for example, water. The cooling medium is preferably water, because (i) water is chemically neutral to the long object made of a thermoplastic adhesive and (ii) water is easily handled. Further, in view of the above, the cooling equipment for use in the cooling step is preferably a water pool or water channel containing water.

The temperature of the cooling medium can be any temperature lower than the temperature of an extruded product immediately after extrusion (i.e., long object immediately after discharge). Meanwhile, the temperature of the cooling medium is preferably a temperature higher than the melting point of the cooling medium. In a case where the cooling medium is water, the temperature of the cooling medium falls within the range of preferably 1° C. to 20° C., more preferably 3° C. to 15° C., particularly preferably 5° C. to 10° C., from the viewpoint of efficient cooling of the extruded product. When the temperature of the cooling medium is higher than the melting point of the cooling medium, it is possible to prevent the cooling medium itself from freezing. The temperature of the extruded product immediately after extrusion is substantially equal in value to the above-described temperature of the long object immediately before discharge of the long object. Therefore, the temperature of the cooling medium can be set with reference to the temperature of the long object immediately before discharge of the long object.

FIG. 1 illustrates, as an example, the cooling equipment 102 which includes an entrance 103, a first water channel 104, a second water channel 105, and a third water channel 106. The entrance 103 is provided with one (1) discharge hole (not illustrated).

Further, in FIG. 1, the cooling equipment 102 is configured to be an S-shaped water channel which corresponds to the one discharge hole. The first water channel 104, the second water channel 105, and the third water channel 106 are filled with water as the cooling medium. The arrow heading toward the winder 107 in FIG. 1 passes through the first water channel 104 and reaches the second water channel 105. Then, the arrow turns back in the second water channel 105, and heads toward the winder 107. Note that the third water channel 106 can be used or only the first water channel 104 can be used depending on needs.

### <1-4. Collection Step>

The present production method includes the step of collecting the long object which has been cooled in the cooling step (collection step). The collection step can be a winding step (described later). Alternatively, the collection step can be a step that is not a winding step, in other words, can be a step in which the long object is collected by not winding the long object. Since the thermoplastic adhesive product has been cooled and solidified in the cooling step, it is possible to easily collect the thermoplastic adhesive product in the collection step.

In a case where in the collection step, the long object is collected by not winding the long object, it is possible to use, for example, a method of collecting the long object according to which method the long object is continuously supplied into a container or the like while being aligned in the container or the like. The expression “the long object is continuously supplied . . . while being aligned” means that in a case where the long object has a string shape, for example, the long object is continuously supplied into the container while the long object is caused to follow a circular path in the container or to shift back and forth in the container. On the other hand, in a case where the long object has a sheet shape, for example, the long object is continuously supplied into the container while the long object is folded in the container.

In the present production method, the collection step is preferably a winding step in which the long object is collected by winding the long object. In a case where the collection step is arranged to be a winding step, the risk of entanglement of the long object can be advantageously reduced as compared to the step of collecting the long object by not winding the long object.

In the winding step, the long object (thermoplastic adhesive product) cooled in the cooling step is wound. The winding step can be automatically or manually carried out. Further, the winding step can be carried out with use of a winder as described later or without use of a winder. Since the thermoplastic adhesive product has been cooled and solidified, the thermoplastic adhesive product can be easily wound by the winder. In a case where the winding step is carried out without use of a winder, for example, the long object can be collected by manually winding the long object on a bar-like support (also referred to as a core). In the present production method, the winding step is preferably carried out with use of a winder, from the viewpoint of efficiently collecting the long object and preventing entanglement of the long object during collection of the long object.

The thermoplastic adhesive product wound up, that is, a rolled thermoplastic adhesive product herein may also be referred to as a rolled object or a roll. Since the thermoplastic adhesive product is a long object having a string shape or a sheet shape, the thermoplastic adhesive product is flexible to a suitable degree. This allows the thermoplastic adhesive product to be rolled so as to form a roll.

The winder preferably includes at least one core, bobbin or drum. FIG. 1 illustrates an example of a production apparatus including a winder. In FIG. 1, the winder 107 includes a bobbin 108. Examples of such a winder include a simple-traverse length-measuring bobbin winder TMS60-TC150-B and a double axis rotation-reversible bobbin winder which are manufactured by Yutaka Seisakusho YK, and a drum supply TM4012D and a drum roller TM2560D which are manufactured by Tokyo-IDEAL Co., Ltd. Note that in a case where the winder includes two or more cores, bobbins or drums, the long object having been once wound up on one core, bobbin or drum can be wound off and rewound on another core, bobbin or drum in winding the long object. Further, the winder preferably winds the long object to form a rolled object while measuring the length of the long object being wound. This makes it possible to obtain a roll in which a certain length of the long object is wound up.

In the winding step, the long object is preferably wound at a tension of 1 N to 100 N.

The above tension (hereinafter, also referred to as “winding tension”) falls within the range of preferably 1 N to 100 N, more preferably 1 N to 80 N, even more preferably 20 N to 70 N, particularly preferably 35 N to 64 N. Note that the winding tension should be changed as appropriate depending on a roll diameter of the rolled object. For example, the winding tension can be a tension measured in a case where the roll dimeter of the rolled object falls within the range of 200 mm to 500 mm.

In the winding step, the long object is wound preferably at a rotation speed of 1 RPM to 200 RPM.

The rotation speed falls within the range of preferably 1 RPM to 200 RPM, more preferably 1 RPM to 90 RPM, even more preferably 5 RPM to 50 RPM, particularly preferably 10 RPM to 30 RPM. When the winding tension and/or the rotation speed of winding is/are in the above range(s), it is possible to not only prevent damage to the thermoplastic adhesive product but also efficiently wind the thermoplastic adhesive product.

In the collection step, the long object cooled in the cooling step is collected preferably such that the length of the long object collected falls within the range of 1 m to 1000 m.

This allows for a larger amount of the thermoplastic adhesive product to be automatically introduced into a hot melt tank when the thermoplastic adhesive product is used. Consequently, work efficiency can be improved. Further, the long object needs to be cut only when the length of the long object has reached a desired length. Therefore, production of the above thermoplastic adhesive product, unlike production of a thermoplastic adhesive product in a pillow form or the like, requires no step of sequentially cutting the thermoplastic adhesive product. Therefore, faster production can be achieved.

In order to collect a long object whose length falls within the range of 1 m to 1000 m, it is possible to use, for example, any of the following methods and the like: (a) a method according to which (i) extrusion of a long object is carried out and completed, by using all raw materials which are needed for producing the long object of only a desired length, which falls within the range of 1 m to 1000 m, (ii) the long object is cooled in the cooling step, and (iii) then, the long object is collected by winding or the like; (b) a method according to which (i) the extrusion step is stopped at the time point when the length of a long object extruded in the extrusion step has reached a desired length in the range of 1 m to 1000 m, (ii) the long object thus extruded is cooled and solidified in the cooling step, and (iii) then, the long object is collected by winding or the like; (c) a method according to which (i) a long object cooled in the cooling step is collected by winding or the like, and (ii) the long object is cut at the time point when the length of the long object collected has reached a desired length in the range of 1 m to 1000 m; and (d) a method according to which (i) a long object is cooled in the cooling step, (ii) the long object present in a flow channel is cut at the time point when the length of the long object has reached a desired length in the range of 1 m to 1000 m, and (iii) then, the long object thus cut is collected by winding or the like.

The long object is cut by a cutting mechanism such as a cutter or a knife. Note however that the cutting mechanism does not necessarily have to include a sharp blade, provided that the cutting mechanism is capable of cutting the long object. The cutting mechanism can be configured to have, for example, a plate shape, a bar shape, or a string shape.

### <1-5. Other Steps>

The present production method can include other steps in addition to the extrusion step, the cooling step, and the collection step.

The present production method can include, for example, the step of supplying a raw material of the thermoplastic adhesive (supply step) prior to the extrusion step. The supply step can be carried out by connecting, to the hopper of the extruder for use in the extrusion step, a tank for supplying the raw material of the thermoplastic adhesive. Further, the tank and/or the hopper can be connected with, for example, a melt bath, a Banbury mixer, and/or a kneader.

The present production method can include a drying step in a case where the long object is cooled with use of a liquid cooling medium in the cooling step. In the drying step, the long object cooled in the cooling step is dried. Therefore, in a case where the present production method includes the drying step, the drying step is carried out between the cooling step and the collection step. This makes it possible to more easily collect the long object (thermoplastic adhesive product). In the drying step, drying equipment is used. The drying equipment is not particularly limited in configuration, provided that the drying equipment can dry the long object. The drying equipment can be one including an air blower.

The pressure of air discharged from the air blower falls within the range of preferably 1 kPa to 20 kPa, more preferably 3 kPa to 15 kPa, even more preferably 5 kPa to 10 kPa. When the pressure of the air discharged from the air blower is in the above range, the long object can be efficiently dried while the shape of the long object is retained.

Further, the amount of the air discharged from the air blower falls within the range of preferably 5 NL/min to 20 NL/min, more preferably 3 NL/min to 15 NL/min, even more preferably 5 NL/min to 10 NL/min. When the amount of the air discharged from the air blower is in the above range, the long object can be efficiently dried while the shape of the long object is retained

The temperature of the air discharged from the air blower falls within the range of preferably 5° C. to 30° C., more preferably 10° C. to 25° C., even more preferably 15° C. to 25° C. When the temperature of the air discharged from the air blower is in the above range, the long object can be efficiently dried while a change in properties of the long object is prevented.

Further, the drying equipment can include a sheet capable of absorbing a liquid cooling medium. The long object can be efficiently dried, for example, in a case where the long object after the cooling step is supplied on a belt conveyer which is provided with a sheet capable of absorbing a liquid cooling medium.

### [2. Apparatus for Producing Thermoplastic Adhesive Product]

An apparatus for producing a thermoplastic adhesive product in accordance with an embodiment of the present invention includes: an extruder configured to extrude a long object, which long object is made of a thermoplastic adhesive and has a string or a sheet shape; cooling equipment configured to cool the long object thus extruded from the extruder; and a winder configured to wind the long object thus cooled by the cooling equipment.

The “apparatus for producing a thermoplastic adhesive in accordance with an embodiment of the present invention” herein is referred to simply as “the present production apparatus”. The term “the present production apparatus” by no means limits the apparatus for producing a thermoplastic adhesive product, and merely means one embodiment of the above apparatus for producing a thermoplastic adhesive product.

One example of the present production apparatus is the production apparatus illustrated in FIG. 1. Note that the following omits descriptions (including descriptions on FIG. 1) on the matters having been described in [1. Method for producing thermoplastic adhesive product] above.

The extruder of the present production apparatus extrudes a long object, which is made of a thermoplastic adhesive and has a string shape or a sheet shape.

The cooling equipment of the present production apparatus cools the long object extruded from the extruder. Further, the cooling equipment cools and solidifies the long object extruded from the extruder. This makes it possible to easily wind, by a winder (described later), the long object thus solidified.

Note that preferably, a discharge hole of the extruder is directly connected with the cooling equipment. This makes it possible to immediately cool the long object extruded. In this case, the shape of the long object is more easily retained.

The winder of the present production apparatus winds the long object (thermoplastic adhesive product) cooled by the cooling equipment. Note that the winder can be an automatically-operated winder or a manually-operated winder. One example of the winder is the winder 107 which includes the bobbin 108 as illustrated in FIG. 1. In a case where the present production method is carried out by use of the present production apparatus, the collection step of the present production method is the winding step since the present production apparatus includes a winder.

The winding tension of the winder falls within the range of preferably 1 N to 100 N, more preferably 1 N to 80 N, even more preferably 20 N to 70 N, particularly preferably 35 N to 64 N. Note that the winding tension should be changed as appropriate depending on, for example, a roll dimeter of a rolled object. For example, the winding tension can be a tension measured in a case where the roll dimeter of the rolled object falls within the range of 200 mm to 500 mm.

The rotation speed of winding by the winder falls within the range of preferably 1 RPM to 200 RPM, more preferably 1 RPM to 90 RPM, even more preferably 5 RPM to 50 RPM, particularly preferably 10 RPM to 30 RPM. When the winding tension and/or the rotation speed of winding is/are in the above range(s), it is possible to not only prevent damage to the thermoplastic adhesive product but also efficiently wind the thermoplastic adhesive product.

The present production apparatus can include other configurations in addition to the extruder, the cooling equipment, and the winder. Note that the following configurations each can be directly connected to an inlet hole or a discharge hole of a corresponding one of the extruder, the cooling equipment and the winder, or alternatively, can be connected to the inlet hole or the discharge hole via carrier equipment such as a belt conveyer.

For example, the extruder can include a hopper and to the hopper, a tank for supplying a raw material of the thermoplastic adhesive can be connected. Further, the tank and/or the hopper can be connected with, for example, a melt bath, a Banbury mixer, and/or a kneader.

Furthermore, the present production apparatus can include drying equipment. For example, the present production apparatus can include, between the cooling equipment and the winder, drying equipment for drying the long object discharged from the cooling equipment. This makes it possible to more easily wind the long object (thermoplastic adhesive product). Note that the drying equipment is configured as described earlier.

The present production apparatus preferably includes no cutting mechanism for cutting the long object which has not yet been wound. Since the present production apparatus is an apparatus for obtaining the above-described long object, it is not necessary to include a cutting mechanism for producing a thermoplastic adhesive product in a pillow form or the like. This makes it possible to achieve faster production as compared to a case where the thermoplastic adhesive product is cut sequentially. Note that it is possible to use, in place of the present production apparatus, a production apparatus including a cutting mechanism that is deactivated. The cutting mechanism is configured as described earlier.

Meanwhile, the present production apparatus can include a cutting mechanism only in the winder. This makes it possible to cut the long object after winding so as to obtain long objects (rolls) having a constant dimension. In other words, the present production apparatus includes no cutting mechanism in configurations excluding the winder.

### [3. Thermoplastic Adhesive Product]

The following will discuss a thermoplastic adhesive product produced by the present production method or a thermoplastic adhesive product produced by the present production apparatus (hereinafter, referred to simply as “the present thermoplastic adhesive product”). The term “the present thermoplastic adhesive product” by no means limits the thermoplastic adhesive product, and merely means one embodiment of the thermoplastic adhesive product.

The present thermoplastic adhesive product is a rollable long object which has a string shape or a sheet shape and which includes a thermoplastic adhesive. Note that the following omits descriptions (including descriptions on FIG. 1) on the matters having been described in [1. Method for producing thermoplastic adhesive product] and [2. Apparatus for producing thermoplastic adhesive product] above.

FIG. 3 schematically illustrates one example of the shape of the present thermoplastic adhesive product, and shows one example of the appearance of a long object having a string shape. In FIG. 3, the reference number “10” indicates the thermoplastic adhesive product having a string shape, the reference number “1” indicates a core part constituted by a thermoplastic adhesive, the reference number “2” indicates a non-adhesive material, the reference number “3” indicates one of opposite ends (hereinafter referred to as one end) of the thermoplastic adhesive product 10, the reference number “4” indicates the other of the opposite ends (hereinafter referred to as the other end) of the thermoplastic adhesive product 10, and the reference number “5” indicates an intermediate portion of the thermoplastic adhesive product 10.

As illustrated in FIG. 3, when the thermoplastic adhesive product 10 is cut along plane Z-Z perpendicular to the lengthwise direction of the long object, the length (i.e., the dimension in the lengthwise direction) of the intermediate portion 5 between the one end 3 and the other end 4 is greater than the inner diameter of the cross section. Note that the inner diameter in FIG. 3 refers to the diameter of a circle inscribed in the outer circumference of the non-adhesive material 2.

FIG. 3 illustrates one example of the shape of the thermoplastic adhesive product 10 in which the thermoplastic adhesive constitutes the core part 1 of the thermoplastic adhesive product 10 and the surface of the core part 1 is partially or entirely coated with the non-adhesive material 2. Note, however, that the shape illustrated in FIG. 3 is merely an example. The non-adhesive material is not essential to the present thermoplastic adhesive product. In a case where a thermoplastic adhesive product including a non-adhesive material is to be produced, a raw material of the non-adhesive material should be used in the above-described production apparatus together with a raw material of the thermoplastic adhesive.

The non-adhesive material 2 is used to form a protective coat to protect the core part 1. Note, however, that the thermoplastic adhesive product 10, even without the non-adhesive material 2, can be continuously supplied to a hot melt tank or the like without problems, provided that, for example, even if adjacent faces of the intermediate portion 5 are brought into contact with each other when the thermoplastic adhesive product 10 without the non-adhesive material 2 is collected, the adjacent faces of the intermediate portion 5 can be detached from each other.

Accordingly, the non-adhesive material is not essential to the present thermoplastic adhesive product. Note that, in a case where the thermoplastic adhesive product 10 includes no non-adhesive material 2, the inner diameter in FIG. 3 refers to the diameter of a circle inscribed in the outer circumference of the core part 1.

Assume that the present thermoplastic adhesive product is configured such that, as illustrated in FIG. 3, the thermoplastic adhesive constitutes the core part 1 of the thermoplastic adhesive product and the surface of the core prat 1 is partially or entirely coated with the non-adhesive material 2. In this case, the present thermoplastic adhesive product has the following advantage. That is, advantageously, even if adjacent faces of the intermediate portion 5 are brought into contact with each other when the thermoplastic adhesive product 10 is collected, rolled, bent, or the like, the adjacent faces do not stick to each other even in a case where the core part 1 is constituted by a highly adhesive thermoplastic adhesive. As such, the embodiment illustrated in FIG. 3 is suitable when a highly adhesive thermoplastic adhesive is used.

The non-adhesive material is used to partially or entirely coat the surface of the core part constituted by the thermoplastic adhesive and to form a protective coat to protect the thermoplastic adhesive. The non-adhesive material can be chemically neutral to the thermoplastic adhesive. Alternatively, the protective coat can be chemically compatible with the thermoplastic adhesive. The protective coat can be constituted by a material that is not adhesive to substances outside the protective coat and that is reactive with the thermoplastic adhesive at the boundary between the protective coat and the thermoplastic adhesive (core part).

In any case, it is preferable that there be no need to remove the protective coat from the thermoplastic adhesive and that the protective coat can be processed together with the thermoplastic adhesive during the subsequent use of the present thermoplastic adhesive product. For example, the present thermoplastic adhesive product is preferably configured such that: the thermoplastic adhesive product, whose core part's surface is partially or entirely coated with the non-adhesive material, is introduced into a hot melt tank and thereby the non-adhesive material is allowed to melt.

In a case where the thermoplastic adhesive product includes the non-adhesive material, the amount of the non-adhesive material is preferably 0.5 wt. % to 5 wt. %, more preferably 1 wt. % to 1.5 wt. %, relative to the weight of the thermoplastic adhesive product. The amount of the non-adhesive material is preferably 0.5 vol. % to 5 vol. %, more preferably 1 vol. % to 1.5 vol. %, relative to the volume of the thermoplastic adhesive (core part).

An example of a typical non-adhesive material is a non-adhesive material that contains an olefin-based copolymer (64 wt. % to 74 wt. %), an ethylene-vinyl acetate copolymer (23 wt. % to 33 wt. %), and an additive(s) (not more than 7 wt. %) such that the total is 100 wt. %.

The expression “the surface of the core part is partially coated with the non-adhesive material” means that the surface of the thermoplastic adhesive product does not need to be coated entirely, for example, in a case where (1) the thermoplastic adhesive product is a long object having a string shape or a sheet shape; (2) the thermoplastic adhesive product has a shape that is rollable; and (3) adjacent faces of the core part do not stick to each other.

On one hand, in a case where a highly adhesive thermoplastic adhesive is used, it is more preferable that a larger proportion of the surface area of the core part in the lengthwise direction of the thermoplastic adhesive product be coated with the non-adhesive material. This makes it possible to more unfailingly prevent adjacent faces of the core part from sticking to each other when the thermoplastic adhesive product is collected, rolled, bent, or the like. The above proportion is preferably not less than 80%, more preferably not less than 90%, even more preferably not less than 95%, most preferably 100%.

On the other hand, usually, one end and the other end of the thermoplastic adhesive product are less likely to make contact with the surface in the lengthwise direction of the thermoplastic adhesive product even when the thermoplastic adhesive product is collected, rolled, bent, or the like, as compared to other portions of the surface of the core part. Therefore, the one end and the other end may be or may not be coated with the non-adhesive material.

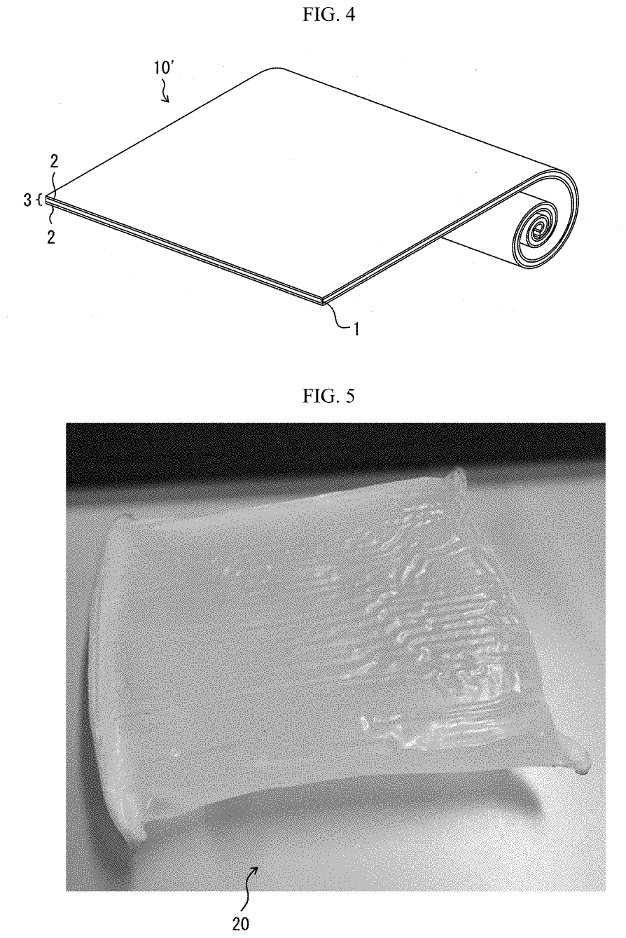

FIG. 4 schematically illustrates one example of the shape of the present thermoplastic adhesive product, and shows how a thermoplastic adhesive product having a sheet shape is rolled up. In FIG. 4, the reference number “10′” indicates the thermoplastic adhesive product, and the reference numbers “1” to “3” are as defined in FIG. 3. The thermoplastic adhesive product 10′ having a sheet shape is such that the length (dimension in the lengthwise direction of the thermoplastic adhesive product 10′) of the intermediate portion is much greater than the length of the long side of a rectangular cross section at one end 3 (this length is a dimension in the widthwise direction of the thermoplastic adhesive product 10′) and the length of the short side of the rectangular cross section (this length is the thickness of the thermoplastic adhesive product 10′). Note that a non-adhesive material 2 is not essential to the thermoplastic adhesive product 10′, as with the case of the thermoplastic adhesive product 10.

The present thermoplastic adhesive products 10 and 10′ are both rollable. That is, the present thermoplastic adhesive product is a long object that has a string shape or a sheet shape and also has flexibility, and therefore is capable of being rolled. The term “roll” can either mean that the thermoplastic adhesive product is wrapped around a core to form a roll or that the thermoplastic adhesive product is coiled into a roll without a core as illustrated in FIG. 4. Since the present thermoplastic adhesive product needs to be rollable, the scope of the present thermoplastic adhesive product does not include thermoplastic adhesive products that are not capable of being rolled, for example, those which are too short to be rolled or those which are too rigid to be rolled.

Meanwhile, the present thermoplastic adhesive product is not necessarily actually rolled, provided that the thermoplastic adhesive product is rollable. In other words, the present thermoplastic adhesive product encompasses a thermoplastic adhesive product which is wound off from a core or the like after having been wound up in the above-described winding step (e.g., by use of the above-described winder). For example, the following configuration (i) or (ii) can be employed for the present thermoplastic adhesive product: (i) about 20 kg to 1 t of a thermoplastic adhesive product having a string shape is packed in a container without being rolled; or (ii) a thermoplastic adhesive product having a sheet shape is folded and packed in a container. Such thermoplastic adhesive products can also be continuously sent into a hot melt tank.

The length of the present thermoplastic adhesive product is preferably not less than 1 m. When the length of the thermoplastic adhesive product is not less than 1 m, a larger amount of the thermoplastic adhesive product can be automatically introduced into a hot melt tank. This can improve work efficiency.

The upper limit of the length of the present thermoplastic adhesive product is not limited in any way, provided that the present thermoplastic adhesive product is collectible. A thermoplastic adhesive product having a longer length is more preferred. Increasing the length of the present thermoplastic adhesive product without an upper limit is technically possible. In practical use, the upper limit of the length of the present thermoplastic adhesive product is preferably, for example, 100 m to 1000 m, in order to achieve easy handling and the like. Similarly, in order to easily roll the thermoplastic adhesive product, the upper limit of the length of the present thermoplastic adhesive product is preferably, for example, 100 m to 1000 m. Note, however, that the upper limit of the length of the present thermoplastic adhesive product is not limited as such, as described earlier.

The weight of the present thermoplastic adhesive product is preferably not less than 10 kg. Conventional thermoplastic adhesive products are introduced into a hot melt tank manually. Therefore, it is not realistic to introduce 10 kg or more conventional thermoplastic adhesive product into a hot melt tank at one time. In contrast, the present thermoplastic adhesive product has the foregoing shape, and therefore can be continuously and automatically introduced into a hot melt tank in an amount much more than that conventionally, manually introduced into the tank.

The upper limit of the weight of the present thermoplastic adhesive product is not particularly limited, and can be selected according to the length of the present thermoplastic adhesive product.

The inner diameter of a cross section perpendicular to the lengthwise direction of the thermoplastic adhesive product is preferably 5 mm to 300 mm, more preferably 5 mm to 100 mm, even more preferably 5 mm to 50 mm, most preferably 5 mm to 15 mm, for faster production and shorter time for the long object to be cooled in the production process.

The present thermoplastic adhesive product preferably has a storage modulus of not more than 5.0×10⁶ Pa and an elongation at break of not less than 200%, more preferably has a storage modulus of not more than 1.0×10⁶ Pa and an elongation at break of not less than 400%, particularly preferably has a storage modulus of not more than 7.0×10⁴ Pa and an elongation at break of not less than 2000%, for the thermoplastic adhesive product to be flexible enough to be easily collected and also for the thermoplastic adhesive product to be flexible enough to be easily rolled.

A thermoplastic adhesive product having the above properties (the above levels of storage modulus and elongation at break) can be obtained by appropriately selecting the compositions of the thermoplastic resin, additive(s), and the like which constitute the thermoplastic adhesive. Alternatively, a commercially-available thermoplastic adhesive having appropriate levels of storage modulus and elongation at break can be used to prepare a thermoplastic adhesive product that has equivalent properties.

The storage modulus is determined based on dynamic viscoelasticity measured under the following conditions. Specifically, the dynamic viscoelasticity is measured at 5° C. with a frequency of 1 Hz with the use of an elastic modulus measurer (ARES rheometer manufactured by TA Instruments) by use of an 8 φ flat plate. On the basis of the dynamic viscoelasticity thus obtained, the storage modulus is determined by the above instrument.

The elongation at break is specified in JIS K6251 (2010), and can be determined by a method in accordance with JIS K6251 (2010). In Examples (describe later), the elongation at break of a thermoplastic adhesive product, which had been processed into a string shape, was measured under the conditions in which tension speed was 100 mm/min., length of test piece was 20 mm, and temperature was 23° C., with the use of a tensile tester measurer (Autograph AGS-X 500N manufactured by Shimadzu corporation).

Further, the present thermoplastic adhesive product preferably has a viscosity of 1000 mPa·S to 100,000 mPa·S at 130° C. The temperature “130° C.” refers to the temperature of the thermoplastic adhesive product. The viscosity can be measured with the use of a known viscometer.

The present thermoplastic adhesive product can be a roll obtained by rolling a thermoplastic adhesive product. Since the present thermoplastic adhesive product is a long object having a string shape or a sheet shape, the thermoplastic adhesive product is flexible to a suitable degree. This allows the thermoplastic adhesive product to be rolled so as to form a roll.

The present thermoplastic adhesive product does not have any other cut surfaces other than its opposite ends, unlike thermoplastic adhesive products in the form of pillows, particles (pellets), or blocks. Accordingly, a user of the present thermoplastic adhesive product can continuously send the thermoplastic adhesive product which has been collected (e.g., wind off a thermoplastic adhesive product which has been formed into a roll). It is therefore possible for the user to continuously and automatically introduce the present thermoplastic adhesive product into a hot melt tank or the like in a production line.

Use of the present thermoplastic adhesive product can achieve the following. For example, in plants, factories, or the like in the paper or wood-related fields dealing with a huge quantity of thermoplastic adhesive product, it is possible to reduce the number of people who introduce the thermoplastic adhesive product into a tank or the like, reduce the number of processes, and the like, and thus possible to dramatically improve work efficiency. It is also possible to avoid troubles such as stoppage of the production line which would result from a reduced amount of the thermoplastic adhesive product in a hot melt tank, and thus possible to eliminate the need for troublesome process control and contribute to efficient and safe production.

The present invention is not limited to the foregoing embodiments, but can be altered by a skilled person in the art within the scope of the claims. The present invention also encompasses, in its technical scope, any embodiment derived by combining technical means disclosed in differing embodiments.

An embodiment of the present invention can be configured as in any of the following [1] through [13].

[1] A method for producing a thermoplastic adhesive product, including the steps of: (a) extruding a long object through a discharge hole of an extruder, the long object being made of a thermoplastic adhesive and having a string or a sheet shape; (b) cooling the long object thus extruded in the step (a); and (c) collecting the long object thus cooled in the step (b).

[2] The method according to [1], wherein: the extruder has two or more discharge holes; and in the step (a), the long object is extruded through the two or more discharge holes.

[3] The method according to [2], wherein: in the step (b), the long object thus extruded through each of the two or more discharge holes is fed into a corresponding one of flow channels.

[4] The method according to any one of [1] through [3], wherein: in the step (c), the long object is collected by being wound.

[5] The method according to claim [4], wherein: the long object is collected by being wound at a tension of 1 N to 100 N.

[6] The method according to [4] or [5], wherein: the long object is collected by being wound at a rotation speed of 1 RPM to 200 RPM.

[7] The method according to any one of [1] through [6], wherein: in the step (c), the long object thus cooled in the step (b) is collected such that the long object has a length which falls within the range of 1 m to 1000 m.

[8] The method according to any one of [1] through [7], wherein: the extruder is a co-extruder.

[9] An apparatus for producing a thermoplastic adhesive product, including: an extruder configured to extrude a long object, which long object is made of a thermoplastic adhesive and has a string or a sheet shape; cooling equipment configured to cool the long object thus extruded from the extruder; and a winder configured to wind the long object thus cooled by the cooling equipment.

[10] The apparatus according to [9], wherein: the winder has a winding tension which falls within the range of 1 N to 100 N.

[11] The apparatus according to [9] or [10], wherein: the winder winds the long object at a winding rotation speed which falls within the range of 1 RPM to 200 RPM.

[12] The apparatus according to any one of [9] through [11], wherein: no cutting mechanism is provided for cutting the long object which has not yet been wound.

[13] The apparatus according to any one of [9] through [12], wherein the extruder is a co-extruder.

### EXAMPLES

The following description will discuss one or more embodiments of the present invention in more detail, on the basis of Examples. Note, however, that one or more embodiments of the present invention are not limited to the following Examples.

### Example 1

A synthetic-rubber-based thermoplastic adhesive (TN286-Z manufactured by MORESCO Corporation) was used as a thermoplastic adhesive. An olefin-based thermoplastic adhesive (PROTECTOR B manufactured by MORESCO Corporation) was used as a non-adhesive material.

The synthetic-rubber-based thermoplastic adhesive and the olefin-based thermoplastic adhesive, which were raw materials, were introduced into a co-extruder (Co-Extrusion Machine S1000 manufactured by JPB Industry) such that the volume ratio of the olefin-based thermoplastic adhesive to the synthetic-rubber-based thermoplastic adhesive was 1%. The co-extruder was configured so that the extruding rate would be 50 kg/h, temperature of cooling water would be 7° C., cooling time would be 10 minutes, and temperature of an extruded product (the temperature of the long object immediately before extrusion from the co-extruder) would be 130° C. The co-extruder was also configured so that the inner diameter of a cross section perpendicular to the lengthwise direction of the extruded product (the diameter of a thermoplastic adhesive product) would be 5 mm to 25 mm. A discharge hole (nozzle) used in the extruder had a diameter of 30 mm.

The co-extrusion was carried out under the above conditions, and the extruded product having a string shape was obtained. The extrusion was carried out without using a cutting mechanism of the co-extruder, and therefore the start of the extrusion resulted in formation of one of the opposite ends of the extruded product and the completion of the extrusion (i.e., all the materials were extruded from the co-extruder) resulted in formation of the other of the opposite ends of the extruded product.

The extruded product, immediately after discharged through the discharge hole of the co-extruder, was placed into a cooling water pool which was used as cooling equipment, and allowed to stay in the cooling water pool. The extruded product was thereby subjected to a cooling step. After the earlier-mentioned cooling time had passed, the extruded product was subjected to a drying step with use of drying equipment including an air blower under the conditions in which air discharge pressure was not less than 5 kPa, air discharge rate was not less than 10 NL/min, air temperature was 15° C. to 25° C., and the like. As a result, a thermoplastic adhesive product 10a having a string shape was obtained. The inner diameter of a cross section perpendicular to the lengthwise direction of the thermoplastic adhesive product 10a was 8 mm.

The thermoplastic adhesive product 10a was found to have a storage modulus of 1.0×10⁶ Pa and an elongation at break of 2000%. The storage modulus and the elongation at break are indicators of flexibility. It was also confirmed that the thermoplastic adhesive product 10a has, at about an elongation at break of 1000%, a breakage peak that is characteristic of the non-adhesive material.

The storage modulus was determined in the following manner, with use of an elastic modulus measurer (ARES rheometer manufactured by TA Instruments). Specifically, dynamic viscoelasticity was measured at 5° C. with a frequency of 1 Hz with the use of an 8 φ flat plate. On the basis of the dynamic viscoelasticity thus obtained, the storage modulus was determined by the above instrument.

The elongation at break of the thermoplastic adhesive product, which had been processed into a string shape, was measured under the conditions in which tension speed was 100 mm/min., length of test piece was 20 mm, and temperature was 23° C., with the use of a tensile tester measurer (Autograph AGS-X 500N manufactured by Shimadzu Corporation).

### Example 1a

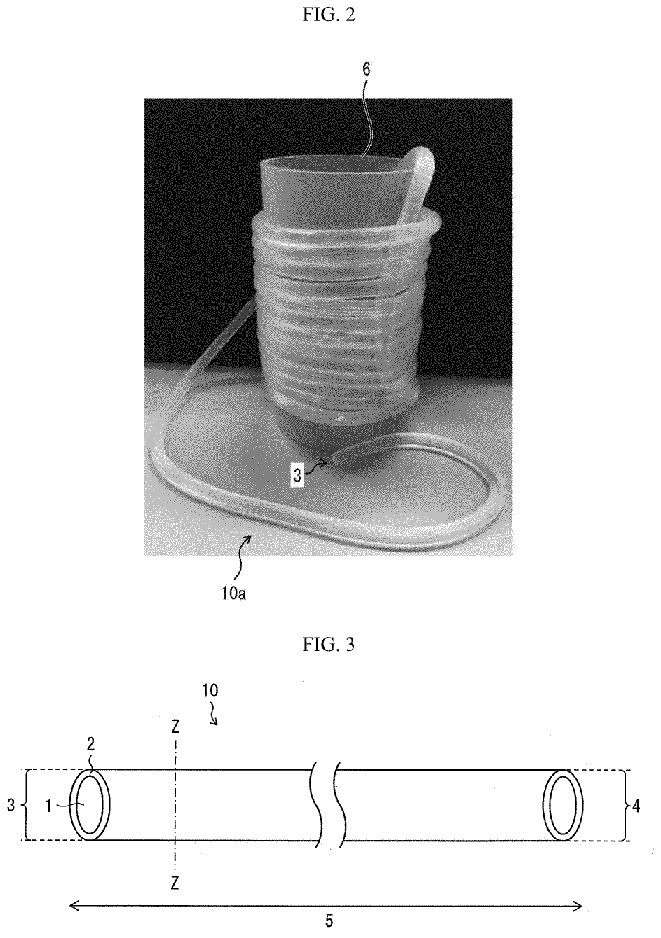

The thermoplastic adhesive product 10a was wrapped around a core (bobbin, having a diameter of 300 mm) to form a roll, by using a winder. This winding step was carried out as a collection step. Note that winding tension was 35 N to 64 N, and bobbin rotation speed was 20 RPM. FIG. 2 shows the appearance of the roll of the thermoplastic adhesive product 10a produced so as to have a string shape in Example 1a. In FIG. 2, the reference number “3” indicates one of the opposite ends (hereinafter referred to as one end) of the thermoplastic adhesive product 10a, and the reference number “6” indicates the core. The thermoplastic adhesive product 10a is a long object having a string shape whose intermediate portion (the portion other than the opposite ends of the thermoplastic adhesive product 10a, i.e., the portion extending in the lengthwise direction) is coated with the non-adhesive material. Even when the thermoplastic adhesive product 10a was wrapped around the core 6, no adhesion was found between any adjacent faces of the intermediate portion. The thermoplastic adhesive product 10a was long and flexible enough to be easily formed into a roll as illustrated in FIG. 2.

### Example 2

The same operations as described in Example 1 were carried out, except that the co-extruder was configured so that the extruding rate would be 200 kg/h and the inner diameter of a thermoplastic adhesive product would be 5 mm to 14 mm, to obtain a thermoplastic adhesive product having a string shape. The thermoplastic adhesive product thus obtained was used as a thermoplastic adhesive product 10b. The inner diameter of the thermoplastic adhesive product 10b was found to be 14 mm. The thermoplastic adhesive product 10b was subjected to the same measurement methods as described in Example 1, and was found to have a storage modulus of 1.0×10⁶ Pa and an elongation at break of 2000%. The storage modulus and the elongation at break are indicators of flexibility. It was also confirmed that the thermoplastic adhesive product 10b has, at about an elongation at break of 1000%, a breakage peak resulting from the non-adhesive material.

### Example 2a

The thermoplastic adhesive product 10b was wrapped around a core to form a roll, by using a winder. This winding step was carried out as a collection step. Note that the winding tension was 42 N to 76.8 N, and the bobbin rotation speed was 26 RPM. As with the thermoplastic adhesive product 10a, the thermoplastic adhesive product 10b was also easily formed into a roll. Even when the thermoplastic adhesive product 10b was wrapped around the core, no adhesion was found between any adjacent faces of the intermediate portion.

### Example 3

The same operations as described in Example 1 were carried out, except that the extruding rate was changed to 400 kg/h, to obtain a thermoplastic adhesive product having a string shape. The obtained thermoplastic adhesive product was used as a thermoplastic adhesive product 10c. The inner diameter of the thermoplastic adhesive product 10b was found to be 25 mm. The thermoplastic adhesive product 10b was subjected to the same measurement methods as described in Example 1, and was found to have a storage modulus of 1.0×10⁶ Pa and an elongation at break of 2000%. The storage modulus and the elongation at break are indicators of flexibility. It was also confirmed that the thermoplastic adhesive product 10b has, at about an elongation at break of 1000%, a breakage peak resulting from the non-adhesive material.

### Example 3a

The thermoplastic adhesive product 10c was wrapped around a core to form a roll, by using a winder. This winding step was carried out as a collection step. Note that the winding tension was 52.5 N to 96 N, and the bobbin rotation speed was 16 RPM. As with the thermoplastic adhesive product 10a, the thermoplastic adhesive product 10c was also easily formed into a roll. Even when the thermoplastic adhesive product 10c was wrapped around the core, no adhesion was found between any adjacent faces of the intermediate portion.

### Comparative Example

A synthetic-rubber-based thermoplastic adhesive (TN286-Z manufactured by MORESCO Corporation) and an olefin-based thermoplastic adhesive (PROTECTOR B manufactured by MORESCO Corporation), which were used in Example 1, were introduced into a co-extruder used in Example 1 such that the volume ratio of the olefin-based thermoplastic adhesive to the synthetic-rubber-based thermoplastic adhesive was the same as that in Example 1. The co-extruder was configured so that the extruding rate would be 500 kg/h to 1250 kg/h, temperature of cooling water would be 5° C. to 10° C., cooling time would be 40 minutes to 60 minutes, and temperature of an extruded product (the temperature of the long object immediately before extrusion from the co-extruder) would be 110° C. to 150° C. A nozzle used in the extruder was configured to have a diameter of 30 mm.

The co-extrusion was carried out under the above conditions, and the extruded product having a pillow shape was obtained. The extruded product was cut by using a cutting mechanism in the co-extruder after a surface-layer portion in contact with the cooling water was cooled and started to solidify. The extruded product, immediately after discharged from the co-extruder, was placed into a cooling water pool and allowed to stay in the cooling water pool, and thereby was cooled. After the earlier-mentioned cooling time had passed, the extruded product was dried by air sent from an air blower. As a result, a pillow-shape thermoplastic adhesive product was obtained.

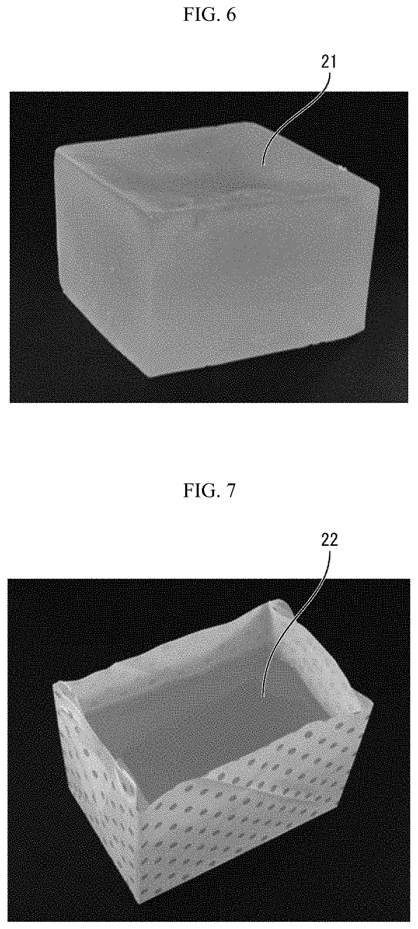

FIG. 5 shows the appearance of a pillow-shape thermoplastic adhesive product 20 (RAC-20Z manufactured by MORESCO Corporation: 110 mm (length)×130 mm (width)×60 mm (thickness), about 350 g). FIG. 6 shows the appearance of a block-shape thermoplastic adhesive product 21 whose surface has been treated to be easily releasable (or detachable) (TN-289 manufactured by MORESCO Corporation: 150 mm (length)×150 mm (width)×100 mm (thickness), about 2.5 kg). FIG. 7 shows the appearance of a block-shape thermoplastic adhesive product 22 (AS-92 manufactured by MORESCO Corporation: 90 mm (length)×140 mm (width)×85 mm (thickness), about 1 kg).

Each of the thermoplastic adhesive products 20 to 22 is in a separate and independent form as illustrated in FIGS. 5 to 7, and is not provided in a continuous series. Such thermoplastic adhesive products 20 to 22 each cannot be continuously supplied to a hot melt tank, unlike the thermoplastic adhesive products 10a to 10c produced in Examples 1 to 3. As such, the thermoplastic adhesive products 20 to 22 require manual operation to be supplied to a hot melt tank, as in conventional techniques.

Furthermore, the thermoplastic adhesive products 20 to 22 have a larger number of end faces, and therefore require a longer cooling step during production. The thermoplastic adhesive products 20 to 22 therefore require more time to be produced than the thermoplastic adhesive products 10a to 10c, which have a simple shape with a smaller number of end faces. In addition, the thermoplastic adhesive products 20 to 22 have an issue in that the temperature range suitable for both cutting and shape retention differs among products and this necessitates precise control of the condition setting of the co-extruder when changing the kinds of product to produce. In contrast, the thermoplastic adhesive products 10a to 10c do not involve such an issue and can be easily produced, because the thermoplastic adhesive products 10a to 10c do not have to be cut.

As is clear from above, the thermoplastic adhesive products 10a to 10c produced by the present production method with an optional use of the present production apparatus are advantageous in that they can be continuously supplied to a hot melt tank and that they can be produced with good efficiency. The present production method can make it easy to produce a thermoplastic adhesive product having such advantages, optionally with use of the present production apparatus.

### INDUSTRIAL APPLICABILITY

An embodiment of the present invention is suitably applicable in the fields dealing with a huge quantity of thermoplastic adhesive product, for example, in paper or wood-related fields.

### REFERENCE SIGNS LIST

1 . . . Core part constituted by thermoplastic adhesive

2 . . . Non-adhesive material

3 . . . One end of thermoplastic adhesive product

4 . . . Other end of thermoplastic adhesive product

5 . . . Intermediate portion of thermoplastic adhesive product

6 . . . Core

10 . . . Thermoplastic adhesive product having a string shape

10′ . . . Thermoplastic adhesive product having a sheet shape

10a . . . Thermoplastic adhesive product produced in

### Example 1

10b . . . Thermoplastic adhesive product produced in

### Example 2

10c . . . Thermoplastic adhesive product produced in

### Example 3

20 . . . Pillow-shape thermoplastic adhesive product

21 . . . Block-shape thermoplastic adhesive product whose surface has been treated to be easily releasable (or detachable)

22 . . . Block-shape thermoplastic adhesive product

100 . . . Production apparatus

101 . . . Extruder

102 . . . Cooling equipment

103 . . . Entrance

104 . . . First water channel

105 . . . Second water channel

106 . . . Third water channel

107 . . . Winder

108 . . . Bobbin

1. An apparatus for producing a thermoplastic adhesive product, comprising:
an extruder configured to extrude a long object, which is made of a thermoplastic adhesive and has a string or a sheet shape;
cooling equipment configured to cool the long object thus extruded from the extruder; and
a winder configured to wind the long object thus cooled by the cooling equipment.

2. The apparatus according to claim 1, wherein:
the winder has a winding tension which falls within the range of 1 N to 100 N.

3. The apparatus according to claim 1, wherein:
the winder winds the long object at a winding rotation speed which falls within the range of 1 RPM to 200 RPM.

4. The apparatus according to claim 1, wherein:
no cutting mechanism is provided for cutting the long object which has not yet been wound.

5. The apparatus according to claim 1, wherein the extruder is a co-extruder.
